(19) United States
(12) Patent Application Publication
(10) Pub. No.: US 2008/0085096 A1
(43) Pub. Date: Apr. 10, 2008

(54) Method, system, apparatus and computer program product for creating, editing, and publishing video with dynamic content

(75) Inventor: Robert S. Marshall, Ijamsville, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: AWS CONVERGENCE TECHNOLOGIES, INC., Germantown, MD (US)

(21) Appl. No.: 11/542,250

(22) Filed: Oct. 4, 2006

(51) Int. Cl. G11B 27/00; G06K 9/36

(52) U.S. Cl. 386/52; 382/284

(57) ABSTRACT

A method of displaying video content includes storing a first instruction with information to control a display of a static video portion, storing a second instruction with information to control a display of a dynamic video portion, and retrieving data corresponding to the first instruction and the second instruction to display the video content including the static video portion and the dynamic video portion. Also described are related methods of editing the video content and making the video content available for display via the Internet.

### BACKGROUND OF THE INVENTION

1. Field of the Invention

The present invention relates to a method, system, apparatus, and computer program product for creating video that includes dynamic content. More particularly, whenever the video including the dynamic content is played back, the dynamic content portion of the video stream may be varied.

2. Description of the Related Art

A non-linear video editor is a computer-based, software-driven system, allowing a user to create video clips in any length, sequence them, and access them instantaneously in any program mode. Non-linear video is based on the idea of a timeline, containing both video and audio tracks, where custom-built clips (of video content) are placed sequentially.

Non-linear editing gives a user the ability to easily change the order of the clips in the timeline. Non-linear editing is commonly performed on a computer using digitally encoded video material with editing software. Once a user has stored the video on a computer that executes the non-linear editing software (e.g. a PC), the user can graphically arrange clips of the video along a timeline to produce a static edited video that includes the same fixed content each time it is viewed.

Non-linear editing techniques for film and television production are known to persons of ordinary skill in the art. Furthermore, non-linear video editing is not limited to professional film and television, and may include consumer software for non-linear editing of home-made videos and pictures to create static edited media such as a slideshow or video.

A computer for non-linear editing of video may include a video editing card, video capture card used to capture analog video, an input used to capture digital video from a digital video camera (such as a FireWire™ socket), as well as video editing software.

Recently, web based editing systems have become available. Web based editing systems can receive video directly from a camera phone over a General Packet Radio Service (GPRS) or 3G mobile connection, and edit the video through a web browser interface.

Furthermore, users may upload static video content to a website for wide scale distribution or publication to the general public.

Furthermore, television broadcast studios can prepare video for news stories. A television broadcast can include live video feeds in a news broadcast, as well as pre-packaged static video content. However, if the television broadcast is ever rebroadcast, the originally live content becomes a static portion of the rebroadcast. Thus, a rebroadcast of the television broadcast includes only static content.

Television news stations may publish news reports over the Internet. In some instances, a television broadcast may be distributed over the internet via live streaming video, or may be streaming video of pre-produced static content. Many television stations make clips from their television broadcast available for viewing over the Internet. However, these video clips do not include dynamic content (i.e., the video clip includes static prerecorded content).

Conventional techniques fail to conveniently publish video with dynamic content.

### SUMMARY OF THE INVENTION

Accordingly, one object of this invention is to provide a method of displaying video content including steps of: storing a first instruction with information to control a display of a static video portion; storing a second instruction with information to control a display of a dynamic video portion; and retrieving data corresponding to the first instruction and the second instruction to display the video content including the static video portion and the dynamic video portion.

Another object of the present invention is to provide a method of displaying video, wherein the static video portion includes a recorded video.

Another object of the present invention is to provide a method of displaying video, wherein the dynamic video portion includes video information of events occurring subsequent to the storing a second instruction.

Another object of the present invention is to provide a method of displaying video further including steps of: executing the first instruction and the second instruction to display the video content including the static video portion and the dynamic video portion, wherein a video information of the dynamic video portion of the executing step changes after performing the step of storing the second instruction.

Another object of the present invention is to provide a method of displaying video, wherein the second instruction includes information regarding an address of a sensor server configured to provide the dynamic video portion.

Another object of the present invention is provide a method of displaying video, wherein the dynamic video portion includes content that varies between subsequent displays of the video content.

Another object of the present invention is to provide a method of editing video content including the steps of: identifying static data to include in the video content; identifying dynamic data to include in the video content; and creating control information to control a display of the video content including the static data and the dynamic data.

Another object of the present invention is to provide method of editing wherein the creating the control information further comprises creating control information related to the identified static data and a command configured to retrieve the selected dynamic data from a server configured to obtain the dynamic data.

Another object of the present invention is to provide a method of editing further including a step of enabling the video content to be displayed via the internet.

Another object of the present invention is to provide a method of editing further including a step of determining a period of time to display the identified dynamic data based on information in the video content.

Another object of the present invention is to provide a method of editing wherein the dynamic data includes weather information.

Another object of the present invention is to provide a method of editing wherein the steps of identifying static data and identifying dynamic data further comprise executing a user interface on a client computer, and wherein the step of creating includes executing instructions on a server computer.

Another object of the present invention is to provide a method of editing wherein an age of the dynamic data is less than 2 seconds.

Another object of the present invention is to provide a method of editing wherein the identifying static data includes identifying at least one of a static video data or a static audio data.

Another object of the present invention is to provide a method of creating information for displaying video content including: identifying dynamic data to include in the video content, the dynamic data being capable of varying between subsequent displays of the video content; identifying static data; and creating a control information to control the display of video content that includes the identified static and dynamic data.

Another object of the present invention is to provide an apparatus configured to display video content including: a storage unit configured to store a first instruction with information to control a display of a static video portion and to store a second instruction with information to control a display of a dynamic video portion; a processor configured to retrieve data corresponding to the first instruction and the second instruction; and a display unit configured to display the video content including the static video portion and the dynamic video portion.

Another object of the present invention is to provide an apparatus, wherein the static video portion includes a recorded video.

Another object of the present invention is to provide an apparatus, wherein the dynamic video portion includes video information of events occurring subsequent to the storage of the second instruction.

Another object of the present invention is to provide an apparatus, wherein the processor is configured to execute the first instruction and the second instruction to display the video content including the static video portion and the dynamic video portion, and a video information of the dynamic video portion changes after the storage of the second instruction.

Another object of the present invention is to provide an apparatus, wherein the second instruction includes information regarding an address of a sensor server configured to provide the dynamic video portion.

Another object of the present invention is to provide an apparatus, wherein the dynamic video portion includes content that varies between subsequent displays of the video content.

Another object of the present invention is to provide an apparatus configured to edit video content including: an identifying unit configured to identify static data to include in the video content and to identify dynamic data to include in the video content; and a creation unit configured to create control information to control a display of the video content including the static data and the dynamic data.

Another object of the present invention is to provide an apparatus, wherein the creation unit is further configured to create control information related to the identified static data and a command configured to retrieve the selected dynamic data from a server configured to obtain the dynamic data.

Another object of the present invention is to provide an apparatus further including: an enabling unit configured to enable the video content to be displayed via the internet.

Another object of the present invention is to provide an apparatus further including: a determination unit configured to determine a period of time to display the identified dynamic data based on information in the video content.

Another object of the present invention is to provide an apparatus, wherein the dynamic data includes weather information.

Another object of the present invention is to provide an apparatus, wherein the identification unit is further configured to execute a user interface on a client computer, and the creation unit is further configured to execute instructions on a server computer.

Another object of the present invention is to provide an apparatus, wherein an age of the dynamic data is less than 2 seconds.

Another object of the present invention is to provide an apparatus, wherein the identification unit is further configured to identify at least one of a static video data or a static audio data.

Another object of the present invention is to provide an apparatus configured to create information for displaying video content including: an identification unit configured to identify dynamic data to include in the video content, the dynamic data being capable of varying between subsequent displays of the video content, and to identify static data; and a creation unit configured to create a control information to control the display of video content that includes the identified static and dynamic data.

Another object of the present invention is to provide a computer readable medium storing instructions, which when executed by a computer cause the computer to perform steps including: storing a first instruction with information to control a display of a static video portion; storing a second instruction with information to control a display of a dynamic video portion; and retrieving data corresponding to the first instruction and the second instruction to display the video content including the static video portion and the dynamic video portion.

Another object of the present invention is to provide a computer readable medium storing instructions which when executed by a computer cause the computer to perform steps including: identifying static data to include in the video content; identifying dynamic data to include in the video content; and creating control information to control a display of the video content including the static data and the dynamic data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of an exemplary system for creating, editing, publishing, and viewing video content that includes dynamic content;

FIG. 2 is another block diagram of an exemplary system for creating, editing, publishing, and viewing video content that includes dynamic content;

FIG. 3A is an exemplary graphical user interface used to create a video file that includes dynamic content;

FIG. 3B is a block diagram of a displayed video that includes, static video content, dynamic content, and an audio track;

FIG. 4 is a block diagram of an exemplary system used to obtain dynamic content;

FIG. 5 is another non-limiting embodiment of a graphical user interface of the present invention used to create a displayed video that includes dynamic data;

FIG. 6 is a non-limiting embodiment of a display shown when a user displays a video created using an embodiment of the present invention; and

FIG. 7 is a block diagram of an embodiment of a computer used to implement the present invention.

### DESCRIPTION OF THE PREFERRED EMBODIMENTS

A deficiency in the above-noted conventional techniques of non-linear video editing and publication/distribution of video content is that conventional techniques do not offer users the ability to integrate dynamic content into their videos.

For example, a user could use a conventional non-linear video editor and create a slideshow (or video) and upload this to the web for people to download and view. However, as there is no dynamic content in this video, each time the video is viewed the video includes the same content.

On the other hand, there is a need to conveniently produce video that can incorporate dynamic content that is displayed when the video is viewed, so that new or updated information may be displayed upon viewing, where the updated information is captured or created subsequent to a time when the video is edited.

Dynamic content refers to information in a portion of published content that may be varied after the published content is created. For example, dynamic content may include an image of an updated weather map that forms a part of a published video, where the weather map includes temperatures obtained after the published video was created. For example, an otherwise static weather report that is viewed at 8 a.m., noon, and 6 p.m. may include dynamic content such as a weather map showing air temperatures captured as of 7 a.m., 11:59 a.m., and 3 p.m., respectively. Each time the weather report is viewed, the dynamic content may be varied without further editing.

The currency (i.e., the freshness or the age) of the dynamic content may also vary, as demonstrated in the previous example.

In the context of weather information, dynamic content includes, but is not limited to, temperature, rate of rain fall, wind speed, wind direction, humidity, barometric pressure, and video camera feeds. In addition, dynamic content may include, but is not limited to, the presentation of any other changing information, such as traffic, prices, sports scores, stocks, values, news, joke of the day, gossip, horoscopes, and entertainment (e.g., movie times, or television listings).

One advantage of dynamic content is that information can be presented that is more current than information that was available at the time the overall content was prepared. Another advantage is that a static shell can be created once, and the dynamic content can be easily varied (as required) so as to populate the static shell with information that is more current than the information that was available at the time the overall content was prepared. For example, static content introducing a national weather map may be created once, and used in perpetuity with dynamic temperature data integrated into the static content. In such a non-limiting embodiment, the production of the static shell is less expensive (i.e., only has to be done once) than conventional techniques.

Moreover, dynamic content may be prepared that is very current, or in “real-time.” The currency of the dynamic content may be as current as 1 day, 1 hour, 1 minute, or 1 second, depending on the type of data. Very current data may be provided (e.g., within a few seconds) if the data is automatically inserted into the overall content without human interaction. In the case of sensor-based information, for example weather data or traffic flow data, such dynamic information may be provided if the user is linked to an electronic network having connections to an array of sensors and weather computers.

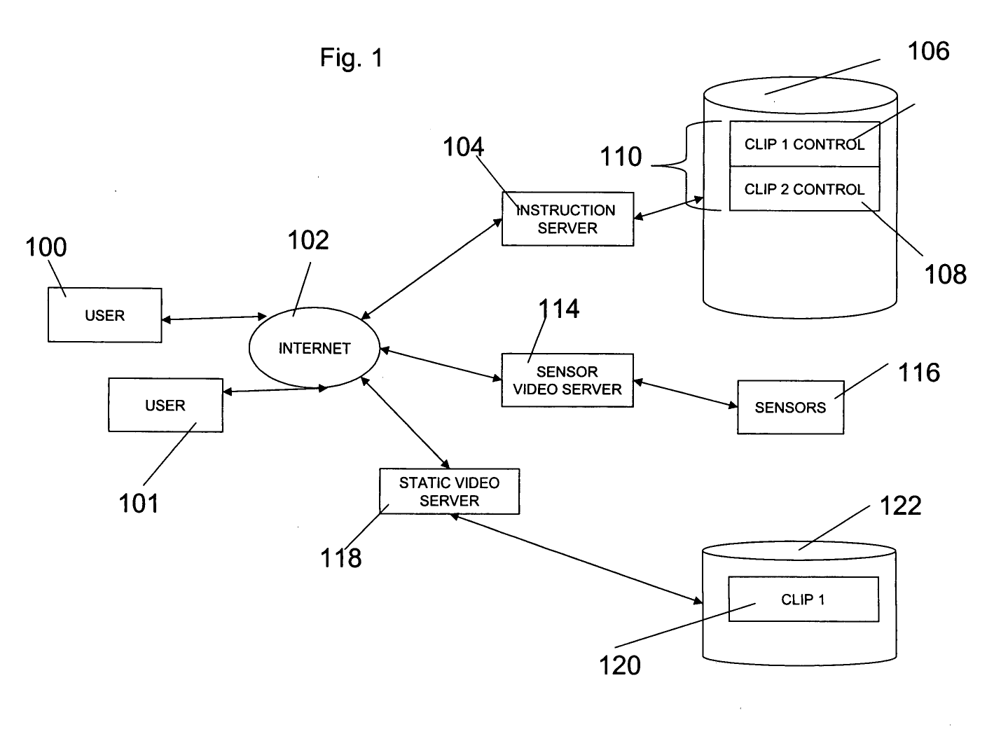

Referring now to the drawings, wherein like reference numerals designate identical or corresponding parts throughout the several views, FIG. 1 is a block diagram of a first embodiment of a system for displaying video content. In this embodiment, information 110 for displaying a video content is stored in a first storage device 112 that is accessible to instruction server 104. The information 110 includes clip control information 106 and 108. Each clip control information 106 and 108 has information to control the display of a corresponding video clip in the video content. Clip control information may include, but is not limited to, display starting time, relative display starting time, display ending time, relative display ending time, and clip duration. Further, if the corresponding video clip is a static video clip, the clip control information may include an address from which the corresponding static video clip may be retrieved. Likewise, if the corresponding video clip is a dynamic video clip, the clip control information may include an address from which the corresponding dynamic video clip may be retrieved.

In this example, a first storage device stores information 110 for displaying a video content that includes two video clips. Information 110 includes clip 1 control information 106 and clip 2 control information 108. Clip 1 control information 106 includes an internet address (e.g., a Universal Resource Locator (URL), or an IP address) for video clip 1 120 stored in a second storage device 122 accessible to static video server 118. Further, clip 1 control information 106 indicates that clip 1 is to be displayed at the beginning of the displayed video content. Clip 2 control information 108 indicates an internet address from which a dynamic video clip may be retrieved and, in this example, indicates that the dynamic video clip starts to be displayed after clip 1 completes. In this example, clip 2 control information 108 indicates that the dynamic video clip is to be retrieved from sensor to video server 114 based and based on information from sensors 116. In this example, the sensor to video server 114 is configured to produce a video stream based on information detected by sensors 116. For example, if sensors 116 include an array of geographically dispersed temperature sensors, the sensor to video server 114 may produce a video stream that depicts a region with current temperatures displayed on the map. In an alternative embodiment, the sensors 116 include video cameras and the sensor to video server 114 produces a stream of video that includes video currently being detected by the video cameras.

When the video content is to be displayed on the user computer 100, the user computer 100 displays clip 1 120 based on clip 1 control information 106 and retrieves and a dynamic video clip produced from sensors 116 based on clip 2 control information 108. The video clips may be transferred to user computer 100 using various communication strategies known to one of skill in the art of internet communication. For example, instruction server 104 may serve a web page to user computer 100, and the served web page may include instructions, based on information 110 and executable by a browser on user computer 100. The instructions, when retrieved and executed by user computer 100, include instructions for first retrieving and displaying clip 1 120 and then for retrieving and displaying a dynamic video clip from sensor to video server 114.

In another embodiment of the present invention, a user 101 can create, edit, and publish video content through the creation of information 110. In this embodiment, the user 100 will connect to instruction server 104 through the Internet 102. The user 101 identifies static and dynamic content to be viewed upon playback. In this example, clip 1 is identified to be the static data displayed upon playback. Clip 2 is identified as dynamic data to be displayed upon playback. Corresponding clip 1 and clip 2 control information is generated and stored in storage device 112.

Clip 1 may be any static video clip or animation. Clip 2 includes dynamic data obtained by sensors 116. Sensors 116 include, but are not limited to, devices which make measurements or record data (such as video cameras).

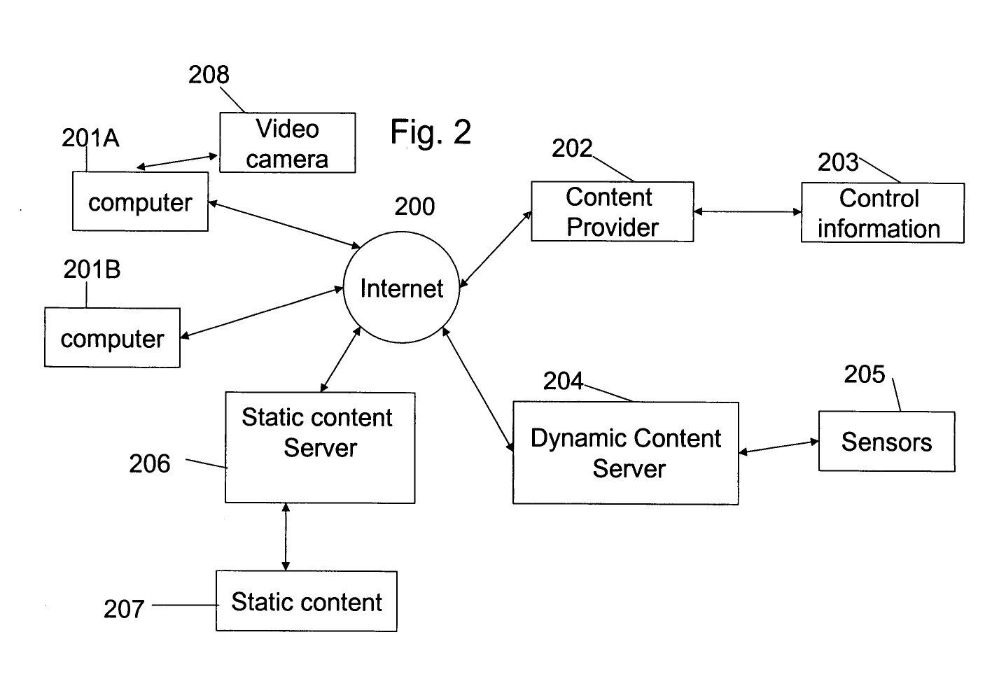

FIG. 2 is a block diagram of another embodiment of a system for creating, editing, publishing and viewing video content that includes static and dynamic content. Computer 201A is computer configured to execute a web browser and communicate with other computers via the Internet. Video camera 208 is connected to computer 201A, and is configured to capture video and transfer the captured video to the computer. Video camera 208 and/or computer 201A may include a microphone and/or speakers. Furthermore, video camera 208 can record live video, or may be a video camera that stores and replays a previously recorded video. For example, video camera 208 may be a cell phone configured to record video and to transmit the recorded video to the computer via a direct connection or a wireless connection. Computer 201A can create information 203, which is control information for retrieving static and dynamic data, and for playing back the static and dynamic data. Static content server 206 is configured to access static content 207 identified by the user of computer 201A. An address of static content 207 identified by the user of computer 201A is stored in information 203.

Sensors 205 obtain dynamic data. Dynamic content server 204 is configured to interface with sensors 205 and obtain the dynamic data. Information 203 includes an address used to retrieve the dynamic data obtained by sensors 205. Alternatively, the dynamic data may include an advertisement that is configured to vary based on factors such as, but not limited to, a price of a purchasable item, a location of display, a time of day, or other factors.

Furthermore, video camera 208 may be used to create the static content. For example, video camera 208 can be used to create an introduction to the dynamic content.

Displayed video content (i.e., static and dynamic data) is included in a displayed video that is displayed on a computer (e.g., computer 201B). Video content provider 202, for example, is a server storing a web page that displays an HTML link, which when executed by a web browser initiates the beginning of a video display process.

The video content may be displayed on computer 201B, which includes a web browser to communicate with other computers via the Internet 200.

In a non-limiting embodiment of the present invention, computer 201B sends a request for video content to content provider 202, by clicking on an executable HTML hyperlink, for example. The request is generated, for example, by the web browser accessing a particular URL address, for example, a URL address of content provider 202. Content provider 202 provides browser 201B with the control information 203 for displaying video content. The control information 203 for displaying a video content includes instructions, which when executed by the browser causes the browser to retrieve the static and dynamic content and arrange the static and dynamic content into a video played back in an order and arrangement determined by the information for displaying the video content. For example, computer 201B retrieves the static content from server 206 and storage device 207, and retrieves the dynamic content from dynamic content server 204. Dynamic content server 204 obtains the dynamic content from sensors 205. Dynamic content may be stored in a buffer before it is transmitted to computer 201B.

Further, the control information 203 may include information regarding the timing of respective portions of the displayed video, video effects and transitions used between or during portions of the displayed video, addresses and timing for audio tracks to be processed with the static or dynamic video, and other instructions regarding the display of the video.

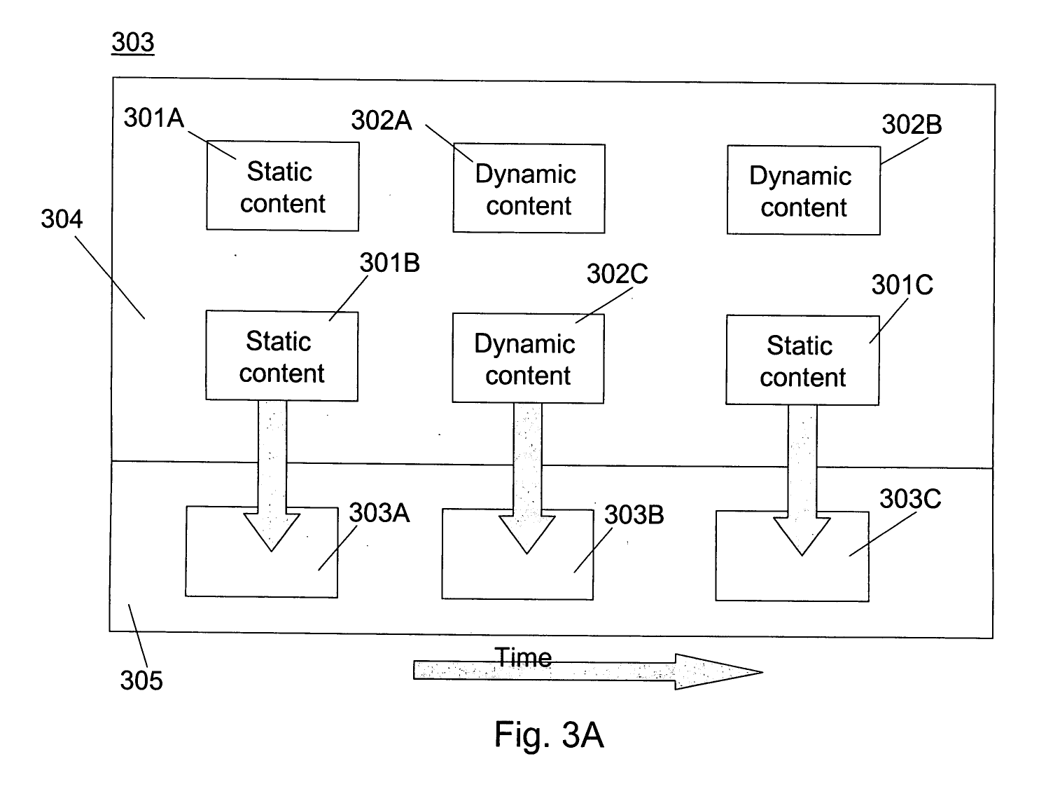

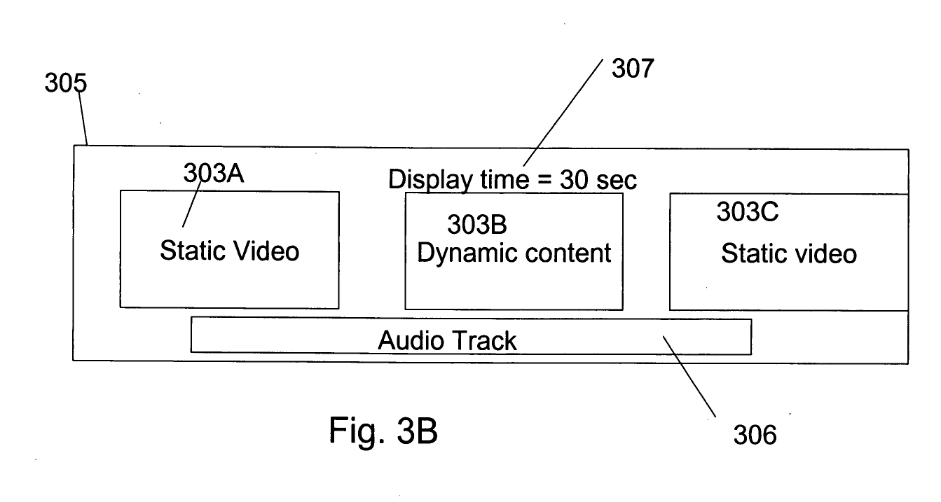

FIG. 3A shows a non-limiting embodiment of a graphical user interface (GUI) 303 used to create, edit, and publish video content that includes dynamic data. The GUI 303 represents the client side of a client-server arrangement. In a non-limiting embodiment of the present invention, a user is able to access the GUI through a web browser operating on the client side device, such as computer 201A, while at least a portion of the program for video editing, creation or publication may be stored and executed on a remote server, such as content provider 202. The GUI 303 includes static content thumbnails 301A-C, which represent static content. Static content may be a video or audio clip, which when played back, always displays the same content. The static content may be stored locally on the client device or on a remote server such as static content server 206. Further, the static content may be generated by the user or by another entity. Static content may be obtained from any source. Sources for static content include, but are not limited to, the Internet, a recorded analog or digital broadcast, content recorded by another, etc. Furthermore, the static content does not have to be video or audio clips. The static content may be a static video clip, a single picture, an audio-track, or combination thereof. The static content may also be a flash animation created using JAVA or another program.

The GUI 303 shown in FIG. 3A also includes dynamic content thumbnails 302A-C, which represent dynamic content. In a non-limiting embodiment of the present invention shown in FIG. 3A, thumbnail 302A represents a link to dynamic content of a radar map, thumbnail 302B represents a link to dynamic content of a temperature map, and thumbnail 302C represents a link to dynamic content of a national weather map.

The user uses the GUI 303 to select the static content thumbnails 301A-C of the static content that the user wants to include in a displayable video content he is creating. The user also uses the GUI 303 to select the dynamic content thumbnails 302A-C of the dynamic content that the user wants to include in the video content he is creating.

FIG. 3A shows window 305, which represents a time wise sequence of clips to be included in a displayed video, and window 304 including available dynamic and static content thumbnails. The user can drag and drop one or more thumbnails from window 304 into slots 303A-C in window 305. In the example shown in FIG. 3A (as indicated by the down-pointing arrows), the user selects static video represented by thumbnail 301B for the first slot 303A, the user selects dynamic content represented by 302C for the second slot 303B, and the user selects static video content 301C to the third slot 303C. The window 305 depicts a time-wise graphical representation of at least a portion of the control information which may be used to display the displayable video.

FIG. 3B shows another exemplary embodiment of window 305 of the GUI 303. In this embodiment, the displayable video that the user creates includes an audio track 306, which can be displayed during the display of at least a portion of the video content. Also, window 305 displays a display time information 307 indicating a period of time the dynamic content will be displayed in the displayed video. Of course, other GUI presentation and control features known to those of ordinary skill in the art of GUI design in video editing may be used to create or display the video control information.

Furthermore, the GUI is not necessary to practice the present invention. On the contrary, the user creating the information for displaying the video content may identify the addresses of where the identified static and dynamic data are located. This may be done using HTML or other computer languages known to those of ordinary skill in the art of computer programming.

In non-limiting embodiments of the present invention, the control information for displaying a video content can include the static data itself, or can include commands (or tags), which when executed by a browser, cause the browser to retrieve the static data from a remote server. If the video content includes the actual static content to be displayed, content provider 202 may provide the static content to computer 201B, rather than an executable instruction. The control information for displaying a video content does not include the dynamic content itself The control information for displaying a video content includes commands (or tags), which when executed by a browser, cause the browser to retrieve the particular dynamic content from a web server that is connected to monitoring devices (e.g., sensors such as video cameras, still cameras, heat sensors, motion sensors, etc . . . ) configured to measure the particular dynamic content.

In other non-limiting embodiments of the present invention, rather than the browser executing the commands (or tags), the content provider 202 (or other server) executes the commands (or tags), retrieves the static and dynamic content, and provides the retrieved static and dynamic content to the user. In other words, the execution of the commands (or tags) of the created information for displaying a video content and the providing the static and dynamic content to the user may be either a client side operation or a server side operation.

Referring to the examples shown in FIGS. 2 and 3A, when computer 201B receives the information for displaying a video content, the browser will first display the static data represented by thumbnail 301B from server 206. The static video data will be presented to the user via a browser operating on computer 201B. Computer 201B will then display the dynamic content represented by thumbnail 302C from dynamic content server 204. The browser operating on computer 201B will parse the information for displaying the video content, determine the locations of the static and dynamic data, and send requests for the static and dynamic data to static content server 206 and dynamic content server 204, respectively. The browser may begin playback as the clips are received, or computer 301B may buffer the video clips locally, and begin playback once all the clips are received. Alternatively, playback may begin once all the static content is received and stored locally, and the dynamic content is received as needed.

Non-limiting embodiments of the present invention include the identification of static and dynamic content pertaining to weather. In the case of weather information, dynamic data such as wind speed, pressure, temperature, wind direction, rate of rain fall that is current as of plus/minus one second is made possible by 8,000 WeatherBug™ Tracking Stations and more than 1,000 cameras primarily based at neighborhood schools and public safety facilities across the U.S. WeatherBug™ (a brand of AWS Convergence Technologies Inc.) maintains the largest exclusive weather network in the world.

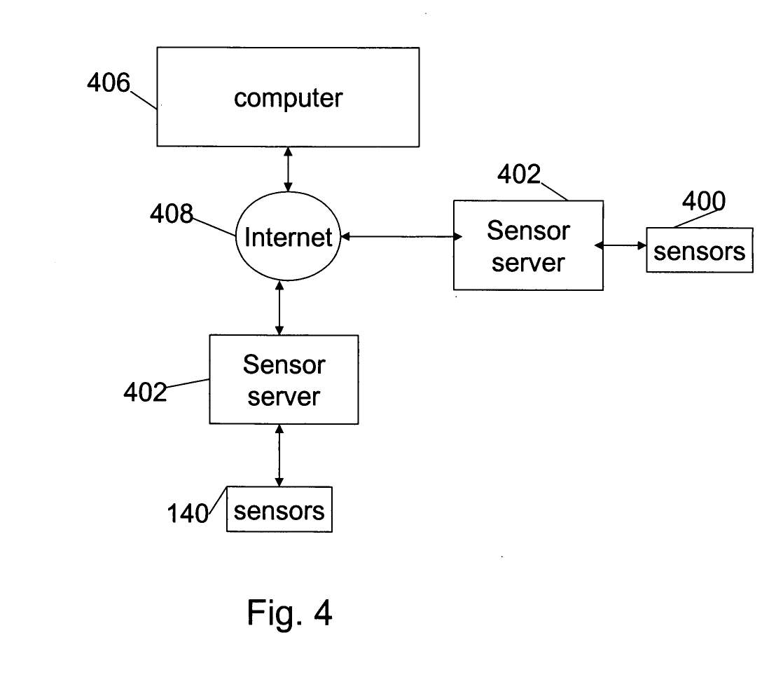

FIG. 4 shows an exemplary array of sensors and weather computers that obtain dynamic weather information. Computer 406 is configured to retrieve data obtained by the sensors 400 by requesting server 404 to transmit data or video through the Internet 408 to computer 406. However, computer 406 may also passively receive the data or video from server 404.

Server 404 may also contact weather computers 402 in order to control sensors 400, such that particular data is measured (i.e., send a command to measure humidity). Furthermore, computer 406 may issue commands to weather computer 402 that change the parameters of the sensors. These changes include, but are not limited to, changing a refresh rate. The sensors 400 are devices known to persons of ordinary skill in the art to measure sensed information. For example, in the domain of weather information, the sensed information may include, but is not limited to, temperature, wind speed, wind direction, humidity, pressure, and rate of rain fall. Furthermore, the sensors may include a video camera. Furthermore, other devices gauge non-weather information. For example, such devices include, but are not limited to, a device which obtains a joke of the day, a device which obtains sports information or financial information, a device which obtains gossip information, a device which obtains horoscope information, a device which obtains varying entertainment information, sensors that gauge traffic flow, and GPS enabled devices that gather location data in real time. These devices can gather data through web APIs, or other methods by which the content is published in an IP enabled environment and retrieved through XML, RSS CAP etc.

In FIGS. 2 and 3A, in the exemplary context of weather information, the dynamic content data represented by thumbnail 302C represents a national weather map including real time dynamic temperatures for major metropolitan areas. Server 204 is configured to store a national map, to use sensors 205 to obtain real time-dynamic temperature information for pre-selected major metropolitan areas, and to populate the national map with the temperature data obtained by sensors 205. The temperature data may be continuously updated by the sensors, or updated at intervals. Dynamic content server 204 is configured to provide the national map, with real-time dynamic temperature data, to computer 201B, which displays the national weather map according to the information for the display of the video content. Computer 201B presents the national map to the user, and displays the map for predetermined period of time. As the national map is displayed to the user, the temperature values may be updated, in real time, as they change, or they may only be updated upon subsequent display of the video.

When a user plays back a video created by the present invention, the dynamic content will be displayed for a predetermined period of time. The predetermined period of time that the browser displays the dynamic content is based on stored control. The predetermined amount of time may be encoded into the control information for the display of the video content as a command, which when executed by the browser causes the browser to display the dynamic content for the predetermined amount of time.

In other non-limiting embodiments of the present invention, the amount of time that the dynamic content is displayed may be controlled by the computer displaying the video. For example, a viewer may click his mouse to signal his browser to stop the display of the dynamic content.

After the predetermined period of time has passed or the user has indicated an end to the display of the dynamic content, computer 201B will display the static content represented by thumbnail 301C and received from server 206.

In a non-limiting embodiment of the present invention, the video played back may be a weather broadcast. In this non-limiting embodiment, the static content represented by thumbnail 301B is video of a person offering narration for the dynamic content that follows. For example, the static content represented by thumbnail 301B is a static video of a person introducing the national weather map that follows. The person states “Let's take a look at temperatures around the nation.” Then, a dynamic video of a national weather map that includes dynamic real time air temperatures for major metropolitan areas. Alternatively, the dynamic video of the weather map may be displayed at the same time a static audio clip of the person is played. When corresponding control information for displaying a video content is executed by a user on Monday at 10:00 am, the temperatures shown on the national weather map may be the current temperatures (e.g., actual temperatures plus/minus one second). When this video is viewed again on the following Tuesday at 5:00 pm, the temperatures shown on the national weather map will not be the temperatures shown on Monday at 10:00 am, but will be the current temperatures (as of Tuesday 5:00 pm, plus/minus one second). The static data may be the same regardless of when the control information for displaying the video content is executed. Thus, in this non-limiting embodiment of the present invention, the displayed video content based on the stored control information can provide a video of current national weather conditions whenever it is viewed without requiring any republishing, reediting, or manual changes to be made to the control information or the stored static video or audio contents.

The sensed information displayed in the video does not have to be real-time data. The currency of the dynamic content may vary, as discussed above. In other non-limiting embodiments of the present invention, sensed information such as the temperatures on the national weather map may be 5 seconds old, 1 minute old, 15 minutes old, an hour old, etc.

In another non-limiting embodiment of the present invention, the video content file also includes an audio-track which can be played back by the browser during the playback of the dynamic content.

In another non-limiting embodiment of the present invention, a user can obtain real time dynamic weather data for the user's local geographic area. In this non-limiting embodiment, control information for displaying a video content received by computer 201B includes information enabling computer 201B to select particular static and dynamic data that is appropriate for the user. For example, particular static and/or dynamic data may be selected based on a location of the user, a location of a computer, a preference of a user, a preference of a publisher, a time of day, an event occurrence, or any other computer or human detectable condition. For example, a user may supply a browser operating on computer 201B with a zip code (or other geographical location identifier), and when the browser obtains the dynamic data, the browser will request the dynamic data appropriate to the zip code. For example, the static video data will be a video of a person stating “Here's the weather in New York City,” when the user provides a zip code for New York City. The browser, using the previously entered zip code, may obtain the local dynamic content, which may be a local weather map with dynamic real time temperature data.

In an alternative embodiment, the browser obtains the geographical location of the user from the user's IP address. The appropriate local dynamic data is obtained using the location derived from the user's IP address.

The dynamic content used in non-limiting embodiments of the present invention may be licensed information or non-licensed information. If the content requires a license, then the user creating the video content file and/or the person viewing the video content file may need to obtain a license to use the dynamic content. In a non-limiting embodiment of the present invention, content provider server 202 is configured to track the use of licensed content, and to process a payment of a fee and/or registration information. The content provider 202 may also disperse collected fees to owners of the licensed content.

Furthermore, dynamic content is not limited to weather information. For example, other embodiments of the present invention provide dynamic content pertaining to traffic, sports, and financial markets. Furthermore, in other embodiments of the present invention, sensors used to obtain the dynamic content can include video cameras. For example, the sensors shown in FIG. 4 can be video cameras configured to record and/or transmit moving images of traffic. Thus, in a non-limiting embodiment of the present invention, the dynamic content can be a live video feed from a camera providing a real-time image of a highway or intersection. In other non-limiting embodiments of the present invention, the dynamic content can be real-time stock quotes, and real-time sports scores and statistics. Again, the currency of this dynamic data may vary as discussed above.

Furthermore, there are no restrictions regarding the substance of the content and the static content does not have to be relevant to the dynamic content.

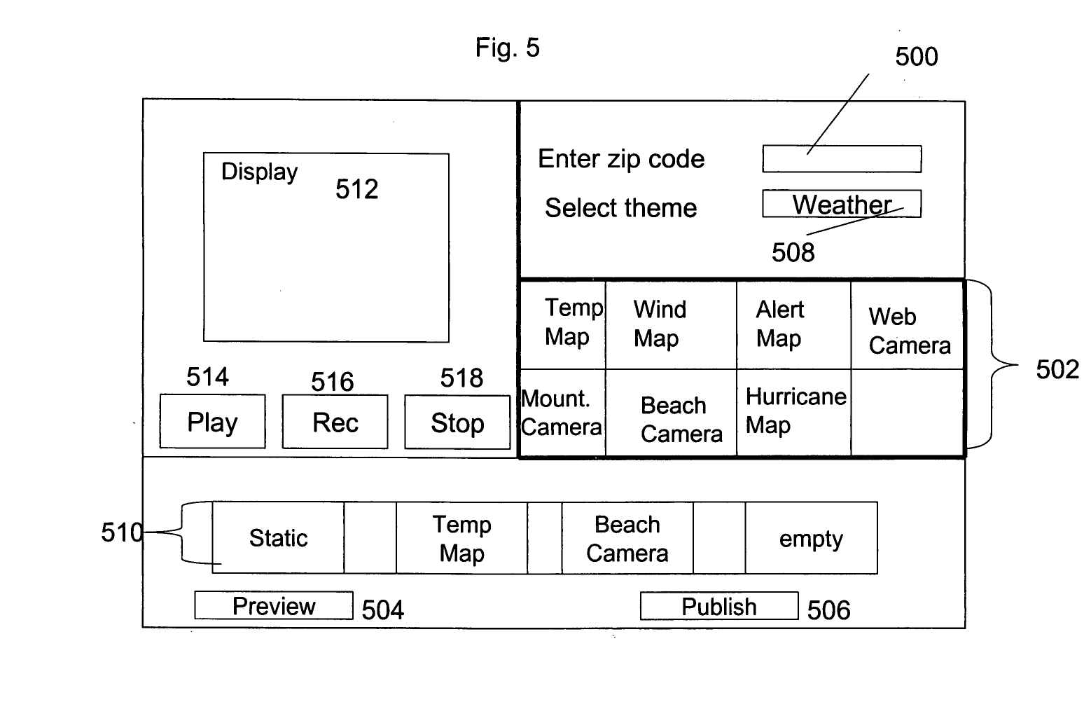

FIG. 5 is another non-limiting embodiment of a graphical user interface used to create and edit information for displaying a video content that includes static and dynamic content. As shown in FIG. 5, user input field 500 allows the user to enter a zip code. Based on the entered zip code, window 500 displays thumbnail images of links to dynamic content pertaining to the entered zip code. For example, window 500 shows links to a temperature map, a wind map, an alert map, a web camera (which is a video feed from a web camera available via the Internet), a mountain camera, a beach camera, and a hurricane camera. The video clip drop zone 510 is a window in which the user can drag and deposit the links of dynamic content that he wants displayed in his video. The user can also drag a link for static content into the video clip drop zone. The GUI shown in FIG. 5 also includes a preview show button 504. Preview show button 504, when selected by the user, plays back the video corresponding to the information for display of video content created by the user in display 512. The GUI of FIG. 5 also includes play button 514 and stop 518, which are used during the preview of the video. Record button 516 is used to record static video/audio content from a video camera and microphone. The preview feature is useful in that it allows the user to review his work before it is published or enabled for display on a computer. Publish button 506, when selected by the user, enables the created information to be used to display a video content on a computer via the Internet (or another network from which it can be accessed). A unique URL (or some other form of identifier) may be assigned to the created information.

The GUI shown in FIG. 5 also includes a drop down menu 508, which includes different themes for the video being created. FIG. 5 shows an example of a weather theme, but other themes such as sports, stocks, financial, traffic etc. can be chosen. Anything that includes changing information could be a theme. The selected theme, alone or in conjunction with the entered zip code, can be used to filter the available links to dynamic content. In another embodiment of the present invention, the selected video them includes information in the created information for displaying a video content that can be used to catalog the created information for displaying a video content.

Further, the GUI of FIG. 5 selects dynamic content based on a zip code, however, the dynamic content may be selected based on any other factor, as described above.

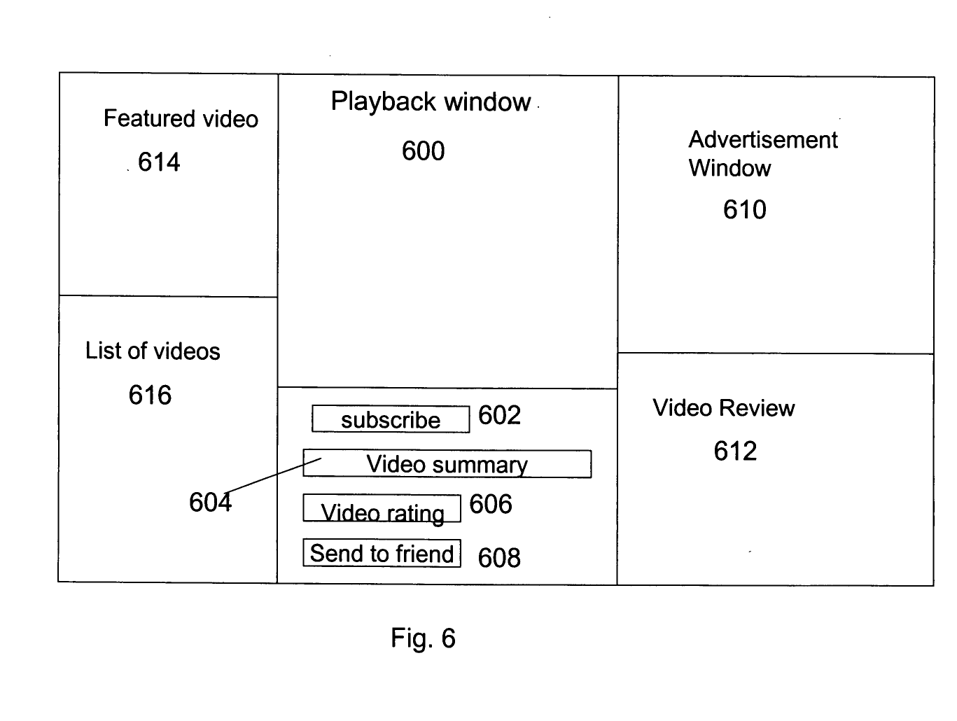

FIG. 6 is a non-limiting example of a display generated at computer 201B when playing back video content which includes dynamic content. FIG. 6 includes playback window 600, in which video of, for example, of “Joe Barsoski's National Weather Outlook” is displayed. The user has the option of subscribing to Joe Bartosik's videos using subscribe button 602. By subscribing, the user can receive an email (or other form of notification) whenever Joe Bartosik publishes another video (for instance Joe Bartosik's traffic report, news report, sports report, joke of the day, gossip, horoscopes, and entertainment report). Furthermore, the display shown in FIG. 6 includes a textual video summary 604. The textual video summary may be written by the creator, and included in the information for displaying a video content, or generated automatically by a corresponding sensor server. The display shown in FIG. 6 also offers users the option of rating the video through video rating 606. In non-limiting embodiments of the present invention, the rating information is used for targeted advertising. The GUI of FIG. 6 also includes a send to friend button 608, which may send a link to the information for displaying video content. The link may be sent using email, text messaging, or other forms of electronic communication know to those of ordinary skill in the art.

The GUI of FIG. 6 also includes advertisement window 610. Based on the content of the video, and information known about the viewer, non-limiting embodiments of the present invention allow for targeted advertising. Alternatively, non-targeted advertising may be used. Also, targeted or non-targeted advertising may form a portion of at least one of the static or dynamic video contents.

Video review window 612 allows the viewer to submit a review of watched video. Featured video window 614 displays featured video. Video list window 616 displays a list of videos. The list of videos may include video available for viewing, and/or videos previously viewed. In addition, the list may be searchable, and arranged in a user selected manner, such as alphabetical order, date of creation, or by user rating.

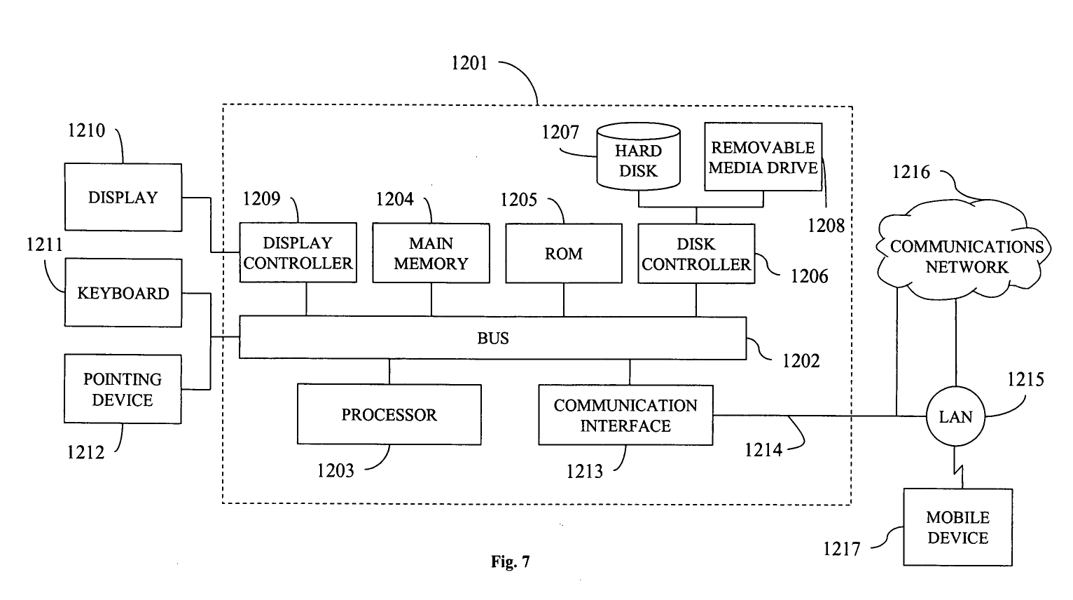

FIG. 7 illustrates a computer system 1201 upon which embodiments of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Numerous modifications and variations of the present invention are possible in light of the above teachings. It is therefore to be understood that within the scope of the appended claims, the invention may be practiced otherwise than as specifically described herein.

1. A method of displaying video content comprising steps of:
storing a first instruction with information to control a display of a static video portion;
storing a second instruction with information to control a display of a dynamic video portion; and
retrieving data corresponding to the first instruction and the second instruction to display the video content including the static video portion and the dynamic video portion.

2. The method of claim 1, wherein the static video portion includes a recorded video.

3. The method of claim 1, wherein the dynamic video portion includes video information of events occurring subsequent to the storing a second instruction.

4. The method of claim 1, further comprising:
executing the first instruction and the second instruction to display the video content including the static video portion and the dynamic video portion,
wherein a video information of the dynamic video portion of the executing step changes after performing the step of storing the second instruction.

5. The method of claim 1, wherein the second instruction includes information regarding an address of a sensor server configured to provide the dynamic video portion.

6. The method of claim 1, wherein the dynamic video portion includes content that varies between subsequent displays of the video content.

7. A method of editing video content comprising the steps of:
identifying static data to include in the video content;
identifying dynamic data to include in the video content; and
creating control information to control a display of the video content including the static data and the dynamic data.

8. The method of claim 7, wherein the creating the control information further comprises creating control information related to the identified static data and a command configured to retrieve the selected dynamic data from a server configured to obtain the dynamic data.

9. The method of claim 7, further comprising:
enabling the video content to be displayed via the internet.

10. The method of claim 8, further comprising:
determining a period of time to display the identified dynamic data based on information in the video content.

11. The method of claim 7, wherein the dynamic data includes weather information.

12. The method of claim 7, wherein the steps of identifying static data and identifying dynamic data further comprise executing a user interface on a client computer, and wherein the step of creating includes executing instructions on a server computer.

13. The method of claim 7, wherein an age of the dynamic data is less than 2 seconds.

14. The method of claim 7, wherein the identifying static data includes identifying at least one of a static video data or a static audio data.

15. A method of creating information for displaying video content comprising:
identifying dynamic data to include in the video content, the dynamic data being capable of varying between subsequent displays of the video content;
identifying static data; and
creating a control information to control the display of video content that includes the identified static and dynamic data.

16. An apparatus configured to display video content comprising:
a storage unit configured to store a first instruction with information to control a display of a static video portion and to store a second instruction with information to control a display of a dynamic video portion;
a processor configured to retrieve data corresponding to the first instruction and the second instruction; and
a display unit configured to display the video content including the static video portion and the dynamic video portion.

17. The apparatus of claim 1, wherein the static video portion includes a recorded video.

18. The apparatus of claim 1, wherein the dynamic video portion includes video information of events occurring subsequent to the storage of the second instruction.

19. The apparatus of claim 1, wherein
the processor is configured to execute the first instruction and the second instruction to display the video content including the static video portion and the dynamic video portion, and
a video information of the dynamic video portion changes after the storage of the second instruction.

20. The apparatus of claim 1, wherein the second instruction includes information regarding an address of a sensor server configured to provide the dynamic video portion.

21. The apparatus of claim 1, wherein the dynamic video portion includes content that varies between subsequent displays of the video content.

22. An apparatus configured to edit video content comprising:
an identifying unit configured to identify static data to include in the video content and to identify dynamic data to include in the video content; and
a creation unit configured to create control information to control a display of the video content including the static data and the dynamic data.

23. The apparatus of claim 20, wherein the creation unit is further configured to create control information related to the identified static data and a command configured to retrieve the selected dynamic data from a server configured to obtain the dynamic data.

24. The apparatus of claim 20, further comprising:
an enabling unit configured to enable the video content to be displayed via the internet.

25. The apparatus of claim 20, further comprising:
a determination unit configured to determine a period of time to display the identified dynamic data based on information in the video content.

26. The apparatus of claim 20, wherein the dynamic data includes weather information.

27. The apparatus of claim 20, wherein the identification unit is further configured to execute a user interface on a client computer, and the creation unit is further configured to execute instructions on a server computer.

28. The apparatus of claim 20, wherein an age of the dynamic data is less than 2 seconds.

29. The apparatus of claim 20, wherein the identification unit is further configured to identify at least one of a static video data or a static audio data.

30. An apparatus configured to create information for displaying video content comprising:
an identification unit configured to identify dynamic data to include in the video content, the dynamic data being capable of varying between subsequent displays of the video content, and to identify static data; and
a creation unit configured to create a control information to control the display of video content that includes the identified static and dynamic data.

31. A computer readable medium storing instructions, which when executed by a computer cause the computer to perform steps comprising:
storing a first instruction with information to control a display of a static video portion;
storing a second instruction with information to control a display of a dynamic video portion; and
retrieving data corresponding to the first instruction and the second instruction to display the video content including the static video portion and the dynamic video portion.

32. A computer readable medium storing instructions which when executed by a computer cause the computer to perform steps comprising:
identifying static data to include in the video content;
identifying dynamic data to include in the video content; and
creating control information to control a display of the video content including the static data and the dynamic data.
